(19) United States
(12) Patent Application Publication
(10) Pub. No.: US 2008/0133109 A1
(43) Pub. Date: Jun. 5, 2008

(54) Addition of Fuel Cell System into Motor Vehicle

(76) Inventor: Grant B. Carlson, Hammondsport, NY (US)

Correspondence Address: BROWN & MICHAELS, PC;400 M & T BANK BUILDING, 118 NORTH TIOGA ST, ITHACA, NY, 14850, US

(21) Appl. No.: 12/029,096

(22) Filed: Feb. 11, 2008

Related U.S. Application Data
(63) Continuation-in-part of application No. 11/425,501, filed on Jun. 21, 2006.
Application No. 11/425,501 is a division of application No. 10/785,342, filed on Feb. 24, 2004, now abandoned.

(51) Int. Cl. F02D 45/00

(52) U.S. Cl. 701/102; 29/888.011; 123/23

(57) ABSTRACT

Apparatus and methods to retrofit a pre-existing vehicle with a fuel cell system. The fuel cell system incorporates a fuel cell for powering an electric motor that has its rotor or armature constructed as part of a driveshaft such that the driveshaft can be turned via the electric motor or by the force of the vehicle's OEM type engine for the purpose of driving at least one wheel of the vehicle without the need for an interconnecting gearbox. The apparatus of the fuel cell system also includes an electronic control unit for controlling the fuel cell system. The electronic control unit can also control aspects of the OEM engine. The engine's OEM Engine Control Module (ECM) and the vehicle's original emission control devices are not modified or replaced in this conversion. With the conversion, both the fuel cell system and the OEM engine burn a common fuel contained in the vehicle's OEM fuel tank where that fuel could for example be: gasoline, diesel, E85, M85, ethanol, methanol, propane, bio-diesel, or hydrogen.

### RELATED APPLICATIONS

This application claims one or more inventions which were disclosed in Provisional Application No. 60/450,446, filed 25 Feb. 2003, entitled “Fuel Cell Drive System”. The benefit under 35 USC §119(e) of the United States provisional application is hereby claimed, and the aforementioned application is hereby incorporated by reference.

This is a continuation-in-part application of co-pending patent application Ser. No. 11/425,501, filed 21 Jun. 2006, entitled “Addition of Fuel Cell System into Motor Vehicle”, which was a divisional application of parent patent application Ser. No. 10/785,342, filed 24 Feb. 2004, now abandoned. The aforementioned applications are hereby incorporated by reference.

### BACKGROUND

1. Field of the Invention

This invention relates to the addition of a fuel cell system into a pre-existing vehicle. The pre-existing or used vehicle is powered by an internal combustion engine. The fuel cell system is an additional method to propel the vehicle. This invention relates more specifically to an apparatus and methods for converting conventionally powered pre-existing vehicles with a fuel cell system. Pre-existing vehicles have internal combustion engines that provide power to turn wheels such to provide traction to propel the vehicle. Internal combustion engines commonly run on gasoline or diesel fuel but can also burn other fuels like, E85, M85, ethanol, methanol, propane, bio-diesel, and even hydrogen. A Hybrid Fuel Cell Vehicle (HFCV) is created from the addition of a fuel cell system into a vehicle with an internal combustion engine wherein each system can provide traction power to propel the vehicle.

2. Related Art

With the advent of fuel cell systems, there is a desire to use them to power motor vehicles. Automotive manufacturers have recently published commercialization efforts towards the production of fuel cell powered motor vehicles. Experimental fuel cell powered vehicles existence today and mass production of light duty passenger cars powered by fuel cells is planned within the next ten years.

The operation of fuel cells is well known and taught in a number of patents. Some of the more relevant patents are U.S. Pat. No. 4,657,829, by McElroy, et al., issued Dec. 27, 1982 along with U.S. Pat. No. 6,306,532, and U.S. Pat. No. 6,368,735. The PEFL fuel cell is disclosed in U.S. Pat. No. 6,306,532. U.S. Pat. No. 6,368,735 discloses the PEM fuel cell and its operation. The basic operation of fuel cells will not be re-taught here but it should be noted that the technology is constantly evolving.

It is also well understood that electrical power produced from fuel cells is the reverse operation of the electrolysis of water wherein hydrogen and oxygen molecules are combined together to form water and create electrical energy. It is also known that the electrical energy created can be used to drive electric motors. The electric motors can be used to drive wheels to propel the vehicle, thus, the concept of an electric motor vehicle.

U.S. Pat. No. 5,641,031 discloses such an electric vehicle with a fuel cell system and an electric traction motor, where the entire fuel cell system is mounted on a common frame and located in the region of the center of gravity of the vehicle. Others patents like U.S. Pat. No. 5,193,635 and U.S. Pat. No. 6,378,637 and U.S. Pat. No. 5,662,184 all teach similar use but different structural arrangements.

There are several important benefits that come from the use of fuel cells in motor vehicles. One is the reduction of the need for the refinement of crude oil into gasoline brought upon by the replacement of the Internal Combustion Engine (ICE). Other benefits include the reduction of air pollution emissions from the ICE, as the only byproduct of a hydrogen-powered fuel cell is water.

The U.S. Government and automakers are primarily concerned with fuel cells for light duty platforms like GM's Hy-Wire concept vehicle. The focus on small passenger cars ignores the benefits that larger motor vehicles could be afforded if they too had a fuel cell system onboard. However the issues of onboard storage of hydrogen vs. vehicle range in respect to vehicle space constraints are significant issues yet to be resolved for larger vehicles. A Hybrid Fuel Cell Vehicle (HFCV) is created by the combination of a fuel cell system and an Internal Combustion Engine (ICE) in a vehicle.

Some variations of hybrid vehicles are disclosed in U.S. Pat. No. 6,378,638 and in U.S. Pat. No. 6,252,331 (Mildice, et al.). Mildice discloses a hybrid vehicle with an ICE that drives an alternator which then in turn powers an electric motor that is coupled to the vehicle drivetrain. U.S. Pat. No. 6,378,638 discloses a drive axle for use in a hybrid vehicle that includes a small ICE and an electric traction motor. A gearbox is used to join the ICE and the motor together such that either or both can propel the vehicle. The gearbox contains both a sun gear and compound planetary gears. The hybrid vehicle uses a large traction battery to power an electric motor to start the vehicle forward, provide bursts of power for acceleration and then uses the internal combustion engine for maintaining cruising speeds on the highway. The gearbox is used to transfer driving torque to the rear wheels from either the electric motor or the ICE or both. Neither of these patents considers the use of fuel cells to power the vehicle, nor the use of a motor design built about a common driveshaft not requiring an interconnecting gearbox.

A recent U.S. patent application Ser. No. 10/279,014, publication no.: US 2003/0141122 by Wolf Boll, discloses a hybrid drive system for a passenger car having an ICE and using an Auxiliary Power Unit (APU) to continuously provide charge to a large traction battery, which in turn provides power to an electric motor. The ICE is connected through a clutch to the electric motor in the hybrid system. The motor is then connected to the vehicle's transmission and the output shaft of the transmission turns the wheels of the vehicle. Although APUs are historically small diesel generators, one of the possible configurations of the APU disclosed is a fuel cell system. The disclosure by Boll states that the APU itself cannot provide sufficient power to start the vehicle forward thus a large traction battery is used to provide such peak power. The traction battery and fuel cell system in the APU are also not sufficient to power the vehicle for operation at highway speeds over longer distances. The Traction battery is expensive and requires significant space. Traction batteries have short life spans when compared to the other major components in the hybrid drive system and so need to be replaced. APUs are standalone units and when used in a motor vehicle have redundant system components to those already in the vehicle. Therefore, the hybrid drive system disclosed by Boll is neither practical nor efficient for implementation into vehicles like SUVs, trucks and buses.

About one half of all new vehicles sold last year in the US where medium-duty vehicles like SUVs and light trucks and of them the big three automakers sold nearly 2 million full size pickup trucks. These vehicles typically weight over 5000 lbs. and require large amounts of power for hauling loads, towing and four-wheel operation. Because of the large power demands and limited available space, it is likely these vehicles will be mostly ignored when it comes to the application of fuel cells. Also ignored will be millions of used pickups, SUVs and classic cars that are driven on U.S. highways today. The pointed acceleration, the sound and feel of the ICE in these cars and trucks are considered desirable features. Sports cars of the “Muscle Car Era” of the late 1960's and early 1970's retain remarkably high resale values for these reasons. But all of these vehicles new or used emit high levels of air pollution and deliver poor gas mileage. It would be a desirable feature to implement fuel cells systems into trucks, SUVs and classic cars in harmony with their ICEs. Even larger cargo carrying trucks and buses could benefit from the addition of a fuel cell system to complement their diesel engines. The resulting hybrid fuel cell vehicle would have the advantages of both reduced fuel consumption and reduced highway emissions. For classic cars it would be desirable to retrofit a fuel cell system in such a way that is could later be removed without irreversible effects to the originality of the vehicle.

Therefore the retrofit of a fuel cell system into a traditional ICE powered motor vehicle is needed. The retrofit of a fuel cell system would also benefit recent generations of Hybrid Electric Vehicles like the Toyota Prius, since they use their ICEs to provide traction power for highway driving. It is desirable for the retrofit of the fuel cell system to have some important features. One important feature is the safety of the vehicle, as the added components should not impair its structural integrity. Also the system should be easy to install, consume little space and done inexpensively. In pre-existing vehicles, the retrofit or conversion should be done without the costs of removing the current engine or transmission or disturbing the engines emission control systems. In the case of a classic car, it would be desirable that the conversion be easily removed allowing for restoration of the vehicle back to its Original Equipment Manufacturer (OEM) condition. It would also be desirable if the fuel cell system and the OEM ICE could use the same fuel for power, whereby only the single original OEM fuel tank and fuel distribution system would be needed. It is desirable that the fuel cell system be large enough to power the vehicle at highway speeds and also to supplement the original engine at lower speeds.

In pre-existing vehicles the fuel cell system requires a computer controller to control and monitor its performance and to determine when best to direct motive force between the ICE and the fuel cell system. If the vehicle's stock OEM engine controller is inadequate in some way to enable the conversion, the additional controller can provide supplemental support such to control both systems. The additional controller could also be used to convert the OEM engine fuel system to operate on other types of fuels like ethanol and methanol.

### SUMMARY

The problem is solved by adding a fuel cell system into a hybrid or traditional ICE powered pre-existing motor vehicle whereby the electric motor (or motors) used in conjunction with the fuel cell system has it's rotor or armature constructed as part of the driveshaft such that the driveshaft can retrofitted in place of the original OEM driveshaft and can be turned as part of the electric motor or by the force of an internal combustion engine without the need of an interconnecting gearbox or a traction battery. The motor housing is connected to the frame of the vehicle such that the electric motor can provide torque to wheels in order to propel the vehicle. An additional computer controller (or controllers) would be needed to control operation of the fuel cell system and the OEM ICE as required. The retrofitted driveshaft can be a “bolt in” replacement of a pre-existing vehicle's driveshaft. For simplicity in the preferred embodiment, only a single motor and driveshaft combination is discussed. However other applications using multiple motors and drive shafts are considered with in the scope and intent of the present invention.

### DRAWINGS

FIG. 1 is a block diagram of the major components of the addition of a Fuel Cell System into a vehicle.

FIG. 2 is a sketch of a 4-pole electric motor showing typical components and location of the retrofit driveshaft of the present invention.

FIG. 3 is a block diagram of a retrofit of a Fuel Cell System into a vehicle.

FIG. 4 is a block diagram of an alternate form of retrofit of a Fuel Cell System into a vehicle.

### DETAILED DESCRIPTION

The advantages of the present invention are that the converted OEM vehicle with a fuel cell system will have greatly reduced fuel consumption and emissions in comparison to the pre-converted vehicle. Traction batteries, typically used in new Hybrid Electric Vehicles would not be necessary to power the electric motor. The Internal Combustion Engine (ICE) may still be required for brisk acceleration and hauling loads, but constant velocity highway operation could be powered solely by the electric motor from the energy provided by the fuel cell. The fuel cell system can assist the OEM ICE under heavy load without the need of an interconnecting gearbox and allow the OEM ICE to run at reduced load and to also shutdown to a low controlled idle when the vehicle is driven at highway speeds. To enable a simple retrofit, the addition of the fuel cell system would include a new driveshaft containing an integral electric motor. This new driveshaft would be a “bolt-in” replacement of the OEM driveshaft. The motor vehicle could easily be restored back to its original condition.

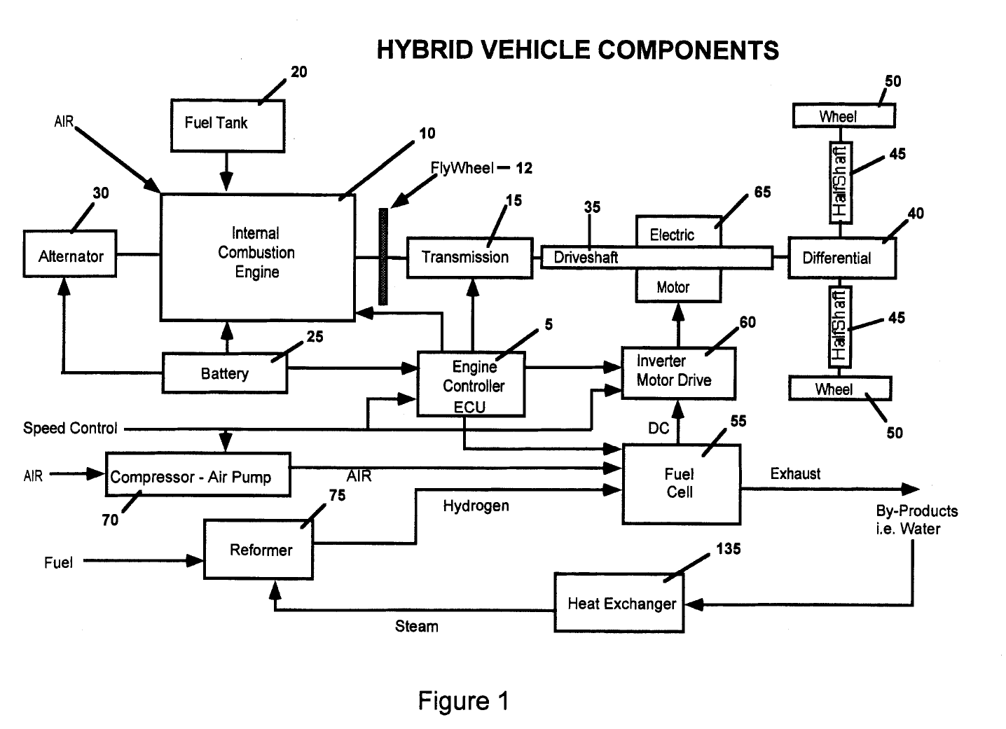

Referring to FIG. 1, the major components of the hybrid vehicle according to the present invention are shown. These components consist of those of a traditional motor vehicle and those added components of a fuel cell system.

The major components of the traditional vehicle are: the Engine Controller Unit (ECU) 5, the Internal Combustion Engine (ICE) 10, the Flywheel 12, the Transmission 15, the Fuel tank 20, the Battery 25, the Alternator 30, the main Driveshaft 35, the transaxle or Differential 40, the transaxle driveshafts or Half-Shafts 45, and the Wheels 50. In older vehicles that do not have fuel injection, the ECU 5 may not be present.

The major components of a fuel cell system are the Fuel Cell 55, the Inverter 60, the Electric Motor 65 (that also uses the Driveshaft 35 as its rotor), the Air Compressor 70 and the Reformer 75, which is optional. If the hybrid vehicle stores hydrogen in a hydrogen fuel tank for direct use by the fuel cell then the Reformer 75 is not needed. An additional component—a Heat Exchanger 135 is needed if the fuel cell system is to be powered by a hydrocarbon (fossil) fuel. The Heat Exchanger 135 is needed to turn water into steam and provide the steam to the Reformer 75, as steam is needed in the reforming process. Instead of the vehicle carrying a separate heater, the Heat Exchanger 135 can get its heat from the Internal Combustion Engine 10. Also, so that the vehicle does not have to carry its own water, the Heat Exchanger 135 can be fed recovered water from the by products of the Fuel Cell 55. It should be appreciated that only the major components of the hybrid fuel cell vehicle are shown in FIG. 1 and that the method and principles of the preferred embodiment of the invention are applicable to a wide variety of fuel cell system and drive train configurations, i.e. using multiple motors on multiple drive shafts or using single or multiple speed transmissions.

As shown in FIG. 1 the ECU 5, which is often, already in place in a traditional vehicle is coupled to the Battery 25 for power and connected via a signal bus to the Internal Combustion Engine (ICE) 10. The ECU 5 is usually also connected to the exhaust system of the ICE 10 (not shown), to the Transmission 15 and to other OEM sensors that monitor water temperature and oil pressure (also not shown). In this configuration, an additional connection from the ECU 5 to the Fuel Cell 55 is also shown. The ECU 5 is useful in monitoring both the correct amount of flow of air and fuel needed by the Fuel Cell 55. The ECU 5 can also be used to monitor the Inverter 60 such that a balance between energy demands required by the vehicle vs. needed motor torque and the required air and fuel flow for the Fuel Cell 55 can best be met. The ECU 5 would also determine based on operating conditions when the vehicle would best be powered by the fuel cell system or by the ICE or both and assist or signal the driver of the vehicle in making the transition if necessary.

The Alternator 30, Battery 25, ICE 10, Flywheel 12, and Transmission 15 all operate as they normally would in the pre-existing vehicle. The transmission 15 when powered by the ICE 10 connects via a Driveshaft 35 to a Differential 40, which in turn splits the driving torque to power the Wheels 50 via the Half-Shafts 45. Note, other drive train configurations like for four wheel drive vehicles, are considered within the scope and intent of the present invention.

The fuel cell system can assist the ICE 10 while under heavy loads or at low speed but once the vehicle has accelerated to a cruising speed, the complete transfer of motive power from the ICE 10 to that of the fuel cell system can occur. Since motor vehicles, when cruising, require much less power than needed for brisk acceleration, the fuel cell system is therefore quite small. This small system (generally about 30 KW for a light duty truck and 100 KW for a bus) reduces the likelihood of major body modifications. The fuel cell system consists of a Fuel Cell 55, Inverter 60 and Electric Motor 65. The Fuel Cell 55 can either obtain Hydrogen from a Hydrogen storage tank (not shown) or from the process of reformation on a hydrocarbon fuel. The Reformer 75 and Heat Exchanger 135 would be required for those systems that wish to use the same hydrocarbon fuel as is used to power the ICE 10. The use of Solid Oxide Fuel Cells (SOFC) as the main component in the fuel cell system would be very beneficial as SOFCs require very little or no fuel reformation. A SOFC is constructed entirely of solid-state materials, utilizing an oxygen ion conductive oxide ceramic as the electrolyte. An Air Compressor 70 is also required to supply a sufficient source of oxygen to the Fuel Cell 55. An exhaust system (not shown) for the Fuel Cell 55 is useful in directing by-products of the process both away from the vehicle in a controlled manner and/or in recycling the by-products for other uses by the ICE, the fuel cell system or by other systems in the motor vehicle.

In the case of a retrofit to a pre-existing vehicle, the original ICE 10 would likely remain on during highway speeds in at least an idle condition while the fuel cell system is operating. Thus energy needed in the reformation of the hydrocarbon fuel could be obtained from the Engine 10. For example in the Heat Exchanger 135, steam could be created by passing water over or near the hot exhaust system of the ICE 10. In the case where a SOFC system is used, the exhaust from the ICE can provide some if not all of the necessary heat required for operation of the SOFC. Also the rotating crankshaft of the ICE 10 could provide energy needed to drive the Air Compressor 70. It is also possible that the Alternator 30 could be used to provide energy needed for the electrolysis of water. Or the Electric Motor 65 could be used as a generator for the same or other purposes—even possibly to replace the Alternator 30. The fuel cell system itself could replace the Alternator 30 as well.

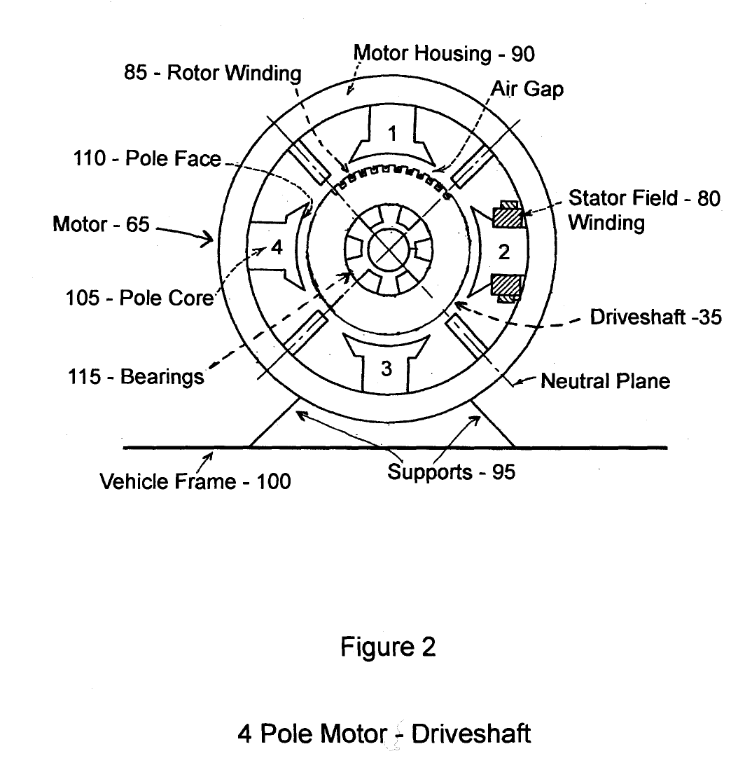

An important attribute of the present invention is the unique operation of the Electric Motor 65 working in common with the Driveshaft 35. The Driveshaft 35 in a traditional vehicle is designed and constructed in such manner as to deliver torque from the ICE 10 through to the Wheels 50. When adding the fuel cell system, a new retrofit driveshaft, would be installed that has its rotor windings placed in the Driveshaft 35. The new retrofit driveshaft and motor combination is shown in FIG. 2. The motor could be of many different designs. A typical AC motor configuration is shown in FIG. 2. The Stator Windings 80 in the Electric Motor 65 and Rotor Windings 85 in the Driveshaft 35 allow for the vehicle to be driven by the Fuel Cell 55. The new driveshaft is also designed and constructed in such a manner as to properly deliver torque from the ICE 10 through to the Wheels 50 when the fuel cell system is off. Other parts of a typical 4 pole AC motor design are shown in FIG. 2. It should be noted that the motor could be constructed with permanent magnets or could be designed using other kinds of configurations either AC or DC with any number of poles. The Pole Face 110 with Pole core 105 is connected to the Motor Housing 90. The Bearings 115 connected about the Driveshaft 35 supports the Motor Housing 90.

One of the useful features of the Electric Motor 65 and Driveshaft 35 combination is the simplicity in which this configuration can be retrofitted into a traditional motor vehicle. Most all drive shafts in ICE powered cars are hollow tubes of metal, (usually made of either steel or aluminum) with universal joints at one or both ends. Drive shafts are generally constructed in such manner that they can be unbolted from vehicle without the expense of having to remove any other major component like the ICE 10 or the Transmission 15. The new motor and driveshaft combination can make use of the space around the old driveshaft as well as the hollow space within it in order to execute the design without requiring significant modifications to the body of the vehicle. Additional modifications required would be to locate and place the other fuel cell system components in the vehicle and to properly connect the Motor Housing 90 through Supports 95 to the Vehicle Frame 100. Lastly, connections from the ECU 5 to the fuel cell system and a speed control (throttle) connection would complete the major modifications.

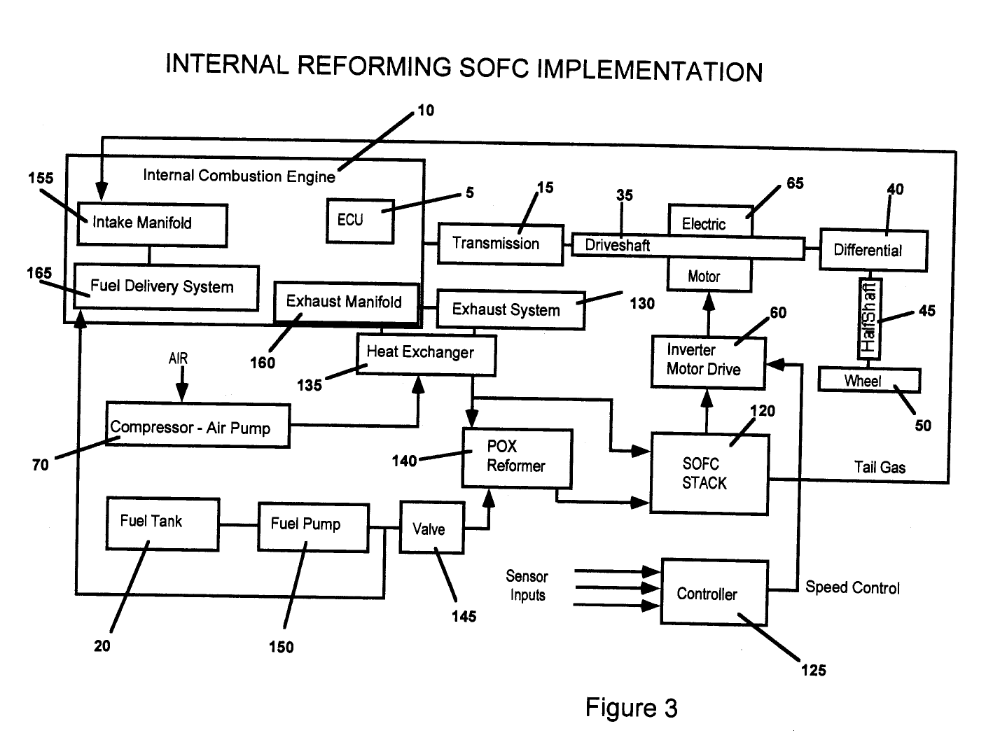

SOFCs have significant advantages when used in the fuel cell system. An example block diagram of a SOFC system implementation is shown in FIG. 3. SOFCs can burn the same hydrocarbon fuel as used by the ICE 10 with little reformation. The result is a significant reduction in system complexity. A POX (Partial Oxidation) Reformer 140 performs simple fuel reformation using heat from the Heat Exchanger 135. A Fuel Pump 150 pumps fuel from the Fuel Tank 20 to the Fuel Valve 145. The fuel is metered by the Fuel Valve 145. The Fuel Pump 150 also sends fuel as it normally would to the engine's Fuel Delivery System 165 where the fuel is vaporized in the Intake Manifold 155.

In FIG. 3, an additional Fuel Cell Control Unit 125 is shown, as the ECU 5 is not typically useable to monitor and control both the OEM engine and OEM fuel system and the added fuel cell system. The OEM ECU 5 and Fuel Cell Controller 125 are shown in FIG. 3 as parallel controllers with power typically provided by the vehicle's battery (not shown). The OEM ECU 5 is typically connected to the OEM Transmission 15 (connection not shown) and to OEM type sensors like those that monitor water temperature and oil pressure (also not shown) as well as an oxygen sensor in Exhaust System 130 (also not shown).

The Fuel Cell System Controller 125 is used to monitor the SOFC stack 120 and monitor the correct amount air, fuel and heat as needed by the SOFC stack 120. The Controller 125 monitors sensors about the fuel cell system and can also monitor the vehicle's OEM sensor inputs as well, like throttle position and engine RPMs. The Controller 125 sends a signal to the Inverter Motor Drive 60 to control the speed of the Electric Motor 65. Also the Controller 125 determines both air and fuel flow needs for the Fuel Cell 120. The Controller 125 is connected to an Air Compressor 70 to regulate the flow of air if one is needed. The Controller 125 may also be connected to other OEM components in the vehicle such as Alternator 30 (not shown), Battery 25 (not shown), ICE 10, Flywheel 12 (not shown), and Transmission 15 which all operate as they normally would in their traditional OEM manner. Typically the OEM Transmission 15 driven by the OEM ICE 10 connects via a Driveshaft 35 to a Differential 40, which in turn splits the driving torque to power the Wheels 50 via the Half-Shafts 45. Other OEM drive train configurations relating for example to the location of the retrofit Driveshaft 35 with Electric Motor 65 in the vehicle are also considered within the scope and intent of the present invention.

FIG. 3 also depicts use of an air compressor to compress incoming air. If needed, the Air Compressor 70 is used to supply a sufficient source of oxygen to the SOFC Stack 120. An OEM Exhaust System 130 connected to the engine's Exhaust Manifold 160 can be used to provide process heat required for operation of the POX Reformer 140. The exhaust from the OEM Engine 10 can also provide some if not all of the necessary heat required for operation of the SOFC Stack 120. As was previously described for FIG. 1, an important attribute of the present invention is the operation of the Electric Motor 65 working in common with the Driveshaft 35. The Driveshaft 35 is designed and constructed in such a manner as to properly deliver torque from the ICE 10 through to the Wheels 50 when the Fuel Cell system is not available. Tail gas exhausted from the SOFC Stack 120 is shown routed back to the Engine 10 for further improvements in system efficiency and reduced emissions.

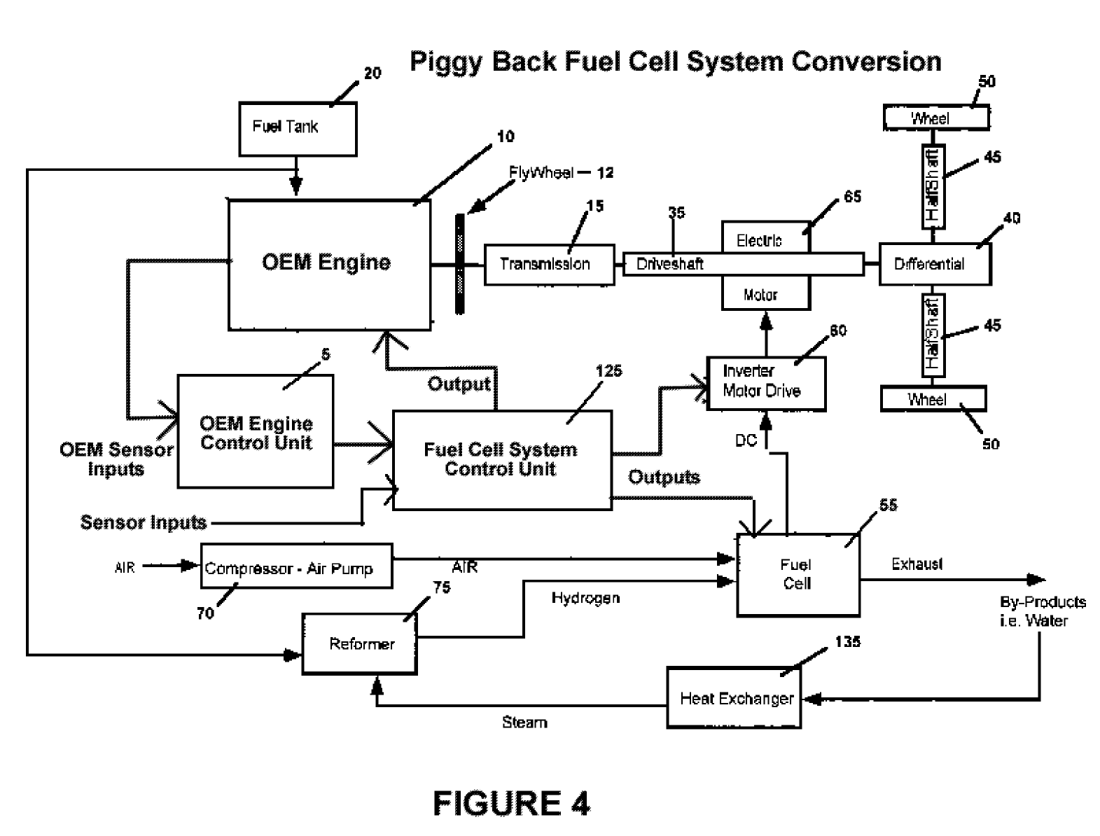

FIG. 4 depicts a different controller configuration than FIGS. 1 and 3. FIG. 4 shows a piggyback controller configuration where the Fuel Cell Control Unit 125 conditions the outputs of the OEM ECU 5. In this system none of the OEM emission control components are unchanged and unaltered when retrofitting a pre-existing vehicle with the Fuel Cell System. In this configuration, the outputs of the OEM ECU 5 that generally control the Engine 10 and the vehicle's OEM fuel system are fed into the Fuel Cell Controller 125. The Fuel Cell Controller 125 then controls the OEM Engine 10, the vehicle's fuel system as well as the added Fuel Cell system. This configuration offers significant advantages over the other configurations as it also allows additional features to be added to the vehicle and engine without replacing or altering the vehicle's OEM emission control system. Some of these additional features include for example, enabling the OEM Engine 10 to operate on alternate fuels like ethanol or methanol or bio-diesel that the original OEM fuel system was not designed to do. Other features could include adding components found in an electric hybrid vehicle. For example, components like a traction battery (not shown) with regenerative braking (not shown) could be added with relative ease as the overall control is handled by the Fuel Cell Controller 125. One other advantage is the retrofit can easily be removed whereby returning the vehicle back to its original operating OEM configuration.

The invention has been described in detail with particular reference to certain preferred embodiments thereof, but it will be understood that variations and modifications can be effected within the spirit and scope of the invention.

What is claimed is:

1. A method of retrofitting a pre-manufactured vehicle having an OEM type internal combustion engine, OEM type of fuel system, OEM type transmission, OEM type driveshaft, OEM type fuel tank using an OEM recommended fuel fed to the engine, and at least one OEM type driven wheel, the method comprising:
adding a fuel cell system powered by the OEM fuel from the OEM type fuel tank;
replacing the OEM type driveshaft with a retrofit driveshaft combined with an electric motor;
powering the electric motor solely with the fuel cell system to rotate the retrofit driveshaft; and
adding an electronic control unit to the pre-manufactured vehicle to control the OEM type internal combustion engine and the fuel cell system so that the electric motor can rotate the retrofit driveshaft alone or in combination with the OEM type internal combustion engine, depending on vehicle traction drive demands.

2. The method of claim 1, wherein the fuel cell system uses a Solid Oxide Fuel Cell (SOFC).

3. The method of claim 2, wherein the exhaust from OEM type internal combustion engine provides heat to the SOFC.

4. The method of claim 1, including feeding an exhaust from the fuel cell system to an intake of the OEM type internal combustion engine.

5. The method of claim 1, including powering the OEM type internal combustion engine and the fuel cell system by the same fuel.

6. The method of claim 1, wherein the electric motor has a rotor coaxial with the driveshaft and a stator fixed to the vehicle frame.

7. The method of claim 1, including using the electronic computer controller unit to control and monitor performance of the internal combustion engine and the fuel cell system and to determine when to direct motive force between the internal combustion engine and the fuel cell system.

8. The method of claim 2, including using the electronic computer controller to monitor the SOFC and air, fuel, and heat needed by the SOFC.

9. The method of claim 1, including using the electronic computer controller unit to monitor a throttle position and an RPM of the internal combustion engine.

10. The method of claim 2, including using the electronic computer controller unit to determine air and fluid flow needs for the SOFC.

11. The method of claim 10, including using the electronic computer controller unit to regulate air flow.

12. A method of retrofitting a pre-manufactured vehicle having an OEM type internal combustion engine, OEM type transmission, OEM type driveshaft, OEM type driven wheel, and OEM type of fuel supply, the method comprising:
adding a fuel cell system powered by the OEM type fuel supply;
replacing the OEM type driveshaft with a retrofit driveshaft combined with an electric motor;
powering the electric motor solely with the fuel cell system to rotate the retrofit driveshaft; and
adding an electronic computer controller unit to control and monitor performance of the OEM type internal combustion engine and the fuel cell system and to determine when to direct motive force between the OEM type internal combustion engine and the fuel cell system.

13. A method of retrofitting a pre-manufactured vehicle having an OEM type internal combustion engine, OEM type transmission, OEM type driveshaft, OEM type driven wheel, and OEM type fuel supply, the method comprising:
adding a fuel cell system powered by the OEM type fuel supply, wherein the fuel cell system uses a Solid Oxide Fuel Cell (SOFC);
replacing the OEM type driveshaft with a retrofit driveshaft combined with an electric motor;
powering the electric motor solely with the fuel cell system to rotate the retrofit driveshaft; and
adding an electronic computer controller unit to monitor the OEM type internal combustion engine and the SOFC and air, fuel, and heat needed by the SOFC.
